(19) United States
(12) Patent Application Publication
(10) Pub. No.: US 2017/0348896 A1
(43) Pub. Date: Dec. 7, 2017

(54) METHOD FOR PRODUCING A THERMOFORMED PRODUCT, AND INSTALLATION AND MACHINE THEREFORE

(71) Applicant: KIEFEL GmbH, Freilassing (DE)

(72) Inventors: Erwin WABNIG, Siegsdorf (DE); Gerhard WIESER, Piding (DE); Thomas HALLETZ, Waging am See (DE); Bernd STEIN, Kirchanschöring (DE)

(21) Appl. No.: 15/536,483

(22) PCT Filed: Dec. 17, 2015
(86) PCT No.: PCT/DE2015/000599

§ 371 Date: Jun. 19, 2017

(30) Foreign Application Priority Data
Dec. 17, 2014 (DE) 10 2014 018 576.1

(51) Int. Cl. B29C 51/02; B29C 59/02; B29C 69/02; B29C 51/10; B29C 51/12; B29C 51/14; B29C 51/22; B29C 51/26; B29C 51/42; B33Y 30/00; B29C 64/112; B29C 45/56; B29K 67/00; B33Y 10/00; B29L 31/00

(52) U.S. Cl. CPC B29C 51/02; B29C 51/421; B29C 59/02; B29C 69/02; B29C 51/10; B29C 51/12; B29C 51/14; B29C 51/22; B29C 51/261; B33Y 30/00; B29C 64/112; B29C 45/561; B29C 2791/001; B29K 2067/046; B29K 2995/006; B33Y 10/00; B29L 2031/7174; B29K 2995/0067

(57) ABSTRACT

A method for producing a thermoformed product on a single machine with several stations and with different tools includes the following steps: (a) melting and homogenizing plastic granules and providing the plastic melt at a preform station; (b) producing a preform at the preform station in a preform cavity; (c) transferring the preform by a transfer carrier to a thermoforming station at the same machine, the thermoforming station having a thermoforming tool having a thermoforming cavity; (d) preferably heating the preform during the transfer; (e) thermoforming of the thermoformed product in the thermoforming cavity. Advantageously, the final thermoformed product is produced directly from the plastic granules using only a single machine, and in particular without any waste, when the preform is dimensioned in such a way that it does not present any excess with respect to the final shape of the product to be produced.

### TECHNICAL FIELD

The disclosure relates to a method for producing a thermoformed product and to an installation and a machine therefor.

### BACKGROUND

Thermoforming is a known and proven method for hot forming thin-walled plastic containers. In DT 2 417 270, for instance, a multiple-stage method is introduced, in which a preform is manufactured in a first operational step, which takes place in an injection compression molding machine. By injection compression molding, the rim of the preform is driven into a circumferential clamping gripper, embodied as a transfer ring. The transfer ring is located in a transfer plate. The preform can thereby be removed from the machine together with the transfer plate and be fed to an additional machine in which thermoforming takes place. For this purpose, a pre-stretching die first embosses a positive shape in a central area of the preform. Subsequently, thermoforming is performed by adding overpressure and/or negative pressure; this was previously termed “deep-drawing”.

The clamps of the transfer ring continue to hold the rim and can now stack the molded thermoformed product, as for instance a cup. For releasing the product from the mold, the clamps are opened.

A similar method is known from U.S. Pat. No. 3,995,763 where, however, the preform itself is not injection compression molded, but supplied in the form of a plastic plate.

A very similar procedure is known from U.S. Pat. No. 7,481,640 B1, U.S. Pat. No. 7,393,202 B1 and from WO 2014/187994 A1.

### SUMMARY

The disclosure is based on the task of providing an improvement or an alternative to the state of the art.

In a first aspect of the present disclosure, this task is achieved by a method for producing a thermoformed product in a single machine with several stations and with different tools, comprising the following steps: (a) melting and homogenizing plastic granules and providing the plastic melt at a preform station; (b) producing a preform at the preform station in a preform cavity, preferably by means of injection molding, injection compression molding; (c) transferring the preform by means of a transfer carrier to a thermoforming station at the same machine, the thermoforming station comprising a thermoforming tool having a thermoforming cavity; (d) preferably heating the preform during the transfer, in particular with a radiation heater; and (e) thermoforming the thermoformed product in the thermoforming cavity.

Some terms will be explained in the following:

“Thermoforming” product means that at least one thermoforming method step is to be performed, in particular for bringing the hot plastic into its final shape. Previously, however, a different type of forming is to be performed on the plastic. Thus, the method has at least two stages: first manufacture of a preform, then execution of the thermoforming step.

Other steps can be provided in addition. Naturally, however, every additional step makes the installation more complex and therefore more expensive. It has been found that by means of the at least two steps proposed here, excellent product qualities and good throughput numbers can already be achieved, and that the machine as such can also be produced at an excellent cost-performance ratio.

As a general rule, it is pointed out that within the framework of the present patent application, indefinite articles and numerals such as “one . . . ”, “two . . . ” etc. are regularly to be understood as indicating a minimum, that is, “at least one . . . ” “at least two . . . ” etc., unless it becomes explicitly clear from the context that only “exactly one . . . ” “exactly two . . . ” etc. can be intended.

Concerning the first aspect of the disclosure, there is such an exception: Production is to take place by means of the at least two steps in exactly one machine. The machine is to have several stations for performing the at least two steps, namely first production of the preform, subsequently production of the final form by thermoforming.

The “melting and homogenizing of plastic granules” is regularly performed by an extruder, which does not have to be part of the machine itself but can also merely ensure that the plastic melt is provided at the preform station.

The “preform station” has a preform cavity, that is, a mold surface with a concave shape for receiving the plastic melt and for direct or indirect shaping of the plastic melt.

The molding methods of injection molding, injection compression molding or compression molding are known to the person skilled in the art.

A “transfer carrier” is to be used for “transferring”. This carrier can be more complex and comprise parts movable with respect to each other which can, for instance, clamp a rim of the preform; but this is explicitly not necessary. Instead, a simple carrying structure, such as a plate, with or without centering device, can also be used.

The thermoforming station is to be arranged “at the same machine”. This means that, for instance, a common safety shutdown switch, a common power supply and/or a common controller for the machine control can be provided. Often the installations are even located in a common engine bed.

It would be another machine, if by means of a transfer station, the transfer carrier would be transferred from one machine to a robot, a conveyor belt or any other unit with a separate line-up and then again a transfer from this transport means to another machine would take place.

The “thermoforming tool” has a cavity which provides the plastic with its final swaged shape by means of overpressure and/or negative pressure in the workpiece or outside the workpiece, respectively.

In addition, the thermoforming station preferably has its own tenter which can be tentered over the workpiece against the cavity so as to create a vacuum-tight or pressure-tight space for the workpiece.

Advantageously, the first aspect of the disclosure makes it possible to arrive directly at the finished thermoformed product starting from plastic granules, and to make production waste-free if the preform is dimensioned accordingly such that it no longer has an excess region over the final product shape to be produced.

It is convenient to commonly use the rim of the preform for gripping or for resting during the transfer. The rim is also the outer border of the preform and of the manufactured thermoformed product in the thermoforming cavity.

In addition, the first aspect of the disclosure can be implemented at very low cost by the operator of such a machine. This is because it is not simply—as in the state of the art—the residual heat from the preforming process that is used for thermoforming; instead, it is already the heat from the extruder that is used, and by means of this heat both preforming and thermoforming can be performed. For melting and homogenizing the plastic granules, naturally very high temperatures are required so that in practice, an extruder operates at temperatures far beyond 100° C. and up to close to 300° C. and heats up, anyway. With the disclosure, it has been realized that it is not only a very precise method to have the transfers take place in one single machine, but that it is also particularly energy-efficient. In addition, the output of production can be scaled very easily without intermediate storage of half-finished products.

In a second aspect of the present disclosure, the task set is achieved by a method for producing a thermoformed product in one or more machines, with several stations and with different tools, comprising the following steps: (a) providing a plastic mass at a preform station, either by melting and homogenizing plastic granules and providing the plastic melt at the preform station, or by providing a solid plastic element, for instance a film section or a film plate, at the preform station; (b) producing a preform at the preform station in a preform cavity, preferably by means of injection molding, injection compression molding or compression molding; (c) transferring the preform by means of a transfer carrier to a thermoforming station, the thermoforming station comprising a thermoforming tool having a thermoforming cavity and the transfer carrier holding the preform only on one side; (d) preferably heating of the preform during the transfer, in particular with a radiation heater; (e) fixing the preform in the thermoforming cavity by means of a tenter of the thermoforming station; and (f) thermoforming of the thermoformed product in the thermoforming cavity.

Concerning the terms of the second aspect of the disclosure, some explanations will be given in the following:

The second aspect of the disclosure applies not only if only one machine is employed; rather, several machines can be used as well, with the semi-finished products being transferred directly or indirectly from one machine to the next during the production process.

Alternatively to melting the granules directly in the machine, it is now also considered to use prefabricated film pieces or plastic plate pieces as input semi-finished products in the process.

For such a process, explicit reference is made to WO2014/187994 A1, the entire disclosure content of which is incorporated by reference here.

Due to the fact that the thermoforming station has its own tenter, the transfer tool can be embodied much simpler than is known in the state of the art; to be more precise, than is known from DT 2 417 270. In a waste-free production process, clamping must always take place in what is called the acceptance region. It requires quite an amount of effort to provide a gripper which fixes the acceptance region from the top and from the bottom, as in DT 2 417 270. On the other hand, it is not necessary to provide a tenter there, for it has been shown, for instance, that the tool front above the die can provide for the sealing.

In the present aspect of the disclosure, however, it is considered advantageous to do the opposite, that is, to simplify the transfer but to provide a conventional tenter at the thermoforming station. The tenter then closes on the acceptance region of the thermoformed product to be produced, in particular on the rim, if it is a cup-shaped product.

According to a third aspect of the present disclosure, the set task is achieved by a method for producing a thermoformed product on one or more machines, with several stations and with different tools, comprising the following steps: (a) providing a plastic mass at a preform station, either by melting and homogenizing of plastic granules and providing the plastic melt at the preform station or by providing a solid plastic element, for instance a film section, at the preform station; (b) producing a preform at the preform station in a preform cavity, preferably by means of injection molding, injection compression molding or compression molding; (c) transferring the preform by means of a transfer carrier to a thermoforming station, the thermoforming station comprising a thermoforming tool with a thermoforming cavity; (d) preferably heating of the preform during the transfer, in particular with a radiation heater; (e) thermoforming of the cup-shaped product in the thermoforming cavity; (f) and an additional step which alters the provided amount of plastic, the preform and/or the thermoformed product, in particular mechanically, optically or sensor technically.

In other words, the third aspect of the disclosure provides for an additional treatment step which has in particular synergistic advantages.

Specific proposals for performing this additional step will be made after introduction of the fourth aspect of the disclosure since the steps generally relate not only to the third aspect of the disclosure but can also relate to the first, second or fourth aspect. Therefore, those aspects of the disclosure will be described first which are mutually independent but can be preferably combined as desired.

It is explicitly pointed out that the additional step can take place at various points in the introduced method. In particular, however, it is envisaged to perform this step on the plastic mass in the preform station, either before or after production or during production of the preform, and/or during transfer of the preform to the thermoforming station and/or at an additional station which is provided additionally to the preform station and to the thermoforming station; and/or at the thermoforming station, either at the preform, before thermoforming, and/or during or after thermoforming.

Here again, it is pointed out that more than one additional step can be provided in addition to the steps listed in the first, second, third or fourth aspects of the disclosure.

In other words, the third aspect of the disclosure achieves the task of integrating a process step for an additional advantage into the production process.

In a fourth aspect of the present disclosure, the task is achieved by a method for producing a thermoformed product in one or more machines, with several stations and with different tools, comprising the following steps: (a) melting and homogenizing plastic granules and providing the plastic melt at a preform station; (b) producing a preform at the preform station in a preform cavity by means of compression molding; (c) transferring the preform by means of a transfer carrier to a thermoforming station, the thermoforming station comprising a thermoforming tool having a thermoforming cavity; (d) preferably heating the preform during the transfer, in particular with a radiation heater; (e) thermoforming the thermoformed product in the thermoforming cavity.

In other words, the fourth aspect of the disclosure provides for using the compression molding method for production of the preform. Prototype tests of widely varying types, performed by the inventors of the same, have shown that this surprisingly results in the states with least strain on the manufactured products.

It is explicitly pointed out that the above-mentioned four aspects of the disclosure can be combined as desired using any number of aspects; that is, aspect 1 can be combined with aspect 2, aspect 1 with aspect 3, aspect 1 with aspect 4, aspect 2 with aspect 3, aspect 2 with aspect 4, aspect 3 with aspect 4, and any combination of three of these aspects or the combination of all four aspects are possible as well.

It can be an advantage if the preform is produced with a thickness profile which deviates from a uniform thickness.

In thermoforming, various parameters can influence the force with which the material is transferred into the cavity. For instance, with a slow deformation of material, for instance with a slow pressing of the pre-stretching die and/or a slow application of negative pressure and/or overpressure, material can be distributed relatively well also to the walls of the thermoformed product; in contrast, more material can be moved to the thermoformed bottom if the movement is faster.

By modifying the pressure ratios, the pressure speeds, the pressure values, the temperature and other parameters, the final product can be influenced as well.

Once it is known how the material deforms during the thermoforming step, the final wall thicknesses of the thermoformed product can be influenced in a targeted manner by providing, for instance, more original material in the regions with strong flux; that is, by providing a thick region in the material during production of the preform.

Thus, the preform can be produced in a targeted manner with thick regions deviating from a uniform thickness. In the particularly simple case of a annular product, this would mean an annular thick region in the preform; or, naturally, a corresponding thin region can also be provided.

As one of the additional steps, in particular the “additional step from the third aspect of the disclosure”, which can, however, be also combined with the other aspects of the disclosure, it is conceivable for the preform and/or the thermoformed product to be printed.

By printing, various information can be provided. Technical prints, but also optical prints can be formed which make the product look more pleasant to the customer; a printer is used for this purpose, preferably a 3D printer; a fluid-jet printer, such as an ink-jet printer, can be used as well.

When the preform, the thermoformed product and/or the printer are rotated, circular surfaces or stripe-like surfaces on the jacket of the thermoformed product can be printed with particular ease.

The 3D printing method can be employed especially when the preform is printed. Here as well, know-how about the deformation conditions during the thermoforming step should be applied during the printing process; for when the preform is printed, normally a geometrical deformation of the printed area will subsequently result during the thermoforming step. This deformation can be taken into account by skilled placement of a 3D print.

As an alternative, it is conceivable that the thermoformed product, that is, a product with a markedly three-dimensional body, can be printed particularly easily with a 3D printer. This will result in excellent quality since no subsequent mechanical deformation of the product will take place.

It is advantageous if as an additional step, an element is placed in the thermoforming cavity for connecting the element to the product.

In a simple case, the “in-mold labeling” method can be employed. Alternatively to a label, a smart tag or an RFID chip can be provided.

Combination of the element with the product can take place on the surface of the product so that the element which has been placed and connected to the product in the end forms the new surface of the combined product; as an alternative, it is conceivable that the element is entirely embedded in the plastic of the preform which is deformed in the thermoforming step.

Another variant for an additional step includes producing a multi-component preform in the preform cavity.

Thus, for instance, a two-component injection process can be provided where one or two of the at least two components are injected. If only one component is injected, the second component can be, for instance, inserted or introduced in some other manner.

In any case, the result of two-component injection is that at least one component is introduced by means of a nozzle, with the other component being introduced with the same nozzle, with a different nozzle or in some other manner. In this way, more complex products can be manufactured.

It is particularly preferable to provide a multi-layer film for thermoforming.

Preferably a multi-layered preform is used for producing a multi-layer film. This can be done with particular ease by injection-molding several layers of different plastics on top of each other. A combined feeding of plastics by means of finished sections and by added injection from nozzles can take place as well; or several sections can be placed on top of each other, with or without a connection means.

Due to the individual layers, a resulting multi-layer film can perform different functions at the same time. In the food industry, for instance, it is often desired to provide an aroma barrier.

If the method is used to produce a capsule such as, in particular, a coffee capsule, a tea capsule, a soup capsule, a different type of brewing capsule or a capsule for producing a soft drink or a medical preparation, then this method can preferably be supplemented by the steps of filling and/or sealing.

Especially if a food capsule is produced, but also for other thermoformed products, it is proposed to provide the plastic mass at the preform station or to provide the plastic granules at least partially, preferably exclusively, using a biologically degradable plastic according to the classification of the brochure by Wolfgang Beier: “Hintergrund: Biologisch abbaubare Kunststoffe” of the Umweltbundesamt Deutschland (Environmental Protection Agency of Germany), August 2009.

Food capsules, especially coffee capsules, can be composted very well since they generally have entirely compostable contents.

Although the composting of plastics can normally not take place in nature, but requires industrial composting, a special waste separation and recycling system or a refund return scheme can ensure that capsules are subjected to industrial composting.

Similarly, providing of the plastic mass at the preform station or of the plastic granules can take place at least partially, preferably entirely, using a polylactide (PLA).

For polylactides as well, it is true that they do not normally decompose in nature, but that under industrial conditions, complete decomposition can be induced within a very short time.

If, in another alternative or additional method step, a barrier layer is applied, in particular comprising an oxide, especially a silicon oxide or an aluminum oxide, it can interact with the biologically degradable plastic, the polylactide and the food contents of the food capsule in special synergy.

An exemplary embodiment provides for a coffee capsule to be produced which is filled with coffee. As a barrier layer, a silicon oxide (SiOLOx) is coated on a simple plastic, such as, in particular, polypropylene. The coffee, the biologically degradable plastic or polylactide, respectively, and the silicon oxide can react very well and even decompose in nature under suitable conditions; in any case, they can decompose very quickly under industrial composting conditions.

As concerns the rim of the preform, it is proposed for it to assume its final shape already during the transfer and to be clamped by the tenter in the acceptance region while it has this final shape.

Therefore, no additional beading is to take place. With yoghurt or drinking cups, for instance, it is conceivable for the relatively sharp edge formed during preforming to be beaded. Since the rim is, however, flattened when being pressed in the thermoforming station between the tenter (generally above the workpiece) and the cavity die (generally below the workpiece), this edge can be fixed particularly well since it has become less sharp and less dangerous by beading.

In other words, this step is to ensure that no further deformation takes place.

A simple heating process is not to be understood as a deformation in this context.

According to another independent idea, the rim can be treated in a method step, in particular by application of a second plastic, a caoutchouc or another additional material.

It is for instance conceivable to produce a coffee capsule and to then apply a soft sealant to the sealing rim. This can also take place already in the preform. While the acceptance region of the preform is pressed together at the thermoforming station, the connection between the rim and the additional material is further improved, especially because the tool in the thermoforming station naturally still heats up from the first heat of the plant.

Before thermoforming, the rim of the preform can be formed as an energy director like it is used in ultrasonic welding or friction welding. An energy director in ultrasonic welding is an edge which is dimensioned such that only a minimum welding bead or none at all is formed since it is precisely the too much foreseen amount of material on the preform that flows over the edge during welding.

With modern technology, and especially with 3D printers, electric oscillating circuits or switching circuits can be printed on the workpiece.

A hologram can also be printed on the thermoformed product.

According to another innovative aspect for the possible additional step, a combined IML (“In-Mold-Labeling”) embossing die can be used, a label being inserted which has a paint edge and an embossing having a mechanical edge, the contour of the paint edge being aligned with the one of the mechanical edge.

It has already been mentioned that the method introduced here is preferably waste-free, so that the manufacturing process for the preform uses precisely the amount of plastic which is required for the thermoformed product.

Of course, an installation with more than one machine is very advantageous for performing a method as described above.

What is particularly advantageous is a machine for performing the method according to the first aspect of the disclosure and preferably also according to one of the other introduced aspects or features, the machine having a preform station, in particular an injection-molding station, an injection compression molding station or a compression molding station, and a thermoforming station, as well as a machine controller and a means of transport for transporting a preform within the machine between the preform station and the thermoforming station, the means of transport preferably having a turntable.

In a prototype made by the inventors, a particularly compact and precisely operating machine with a turntable can be provided.

The turntable preferably has a vertical switch shaft for supplying the various stations.

Above all, the machine controller must be adapted to always index the turntable by 90°, that is, to supply maximally four stations: the preform station and immediately or shortly afterwards, the thermoforming station, and preferably in addition a treatment station and a removal station.

### BRIEF DESCRIPTION OF THE DRAWING

In the following, the disclosure will be described in more detail using an example of embodiment with reference to the drawing wherein

FIG. 1 shows schematically, in perspective view, a machine with a turntable and four tray-shaped carriers for workpieces, and with several stations.

### DETAILED DESCRIPTION OF THE DRAWING

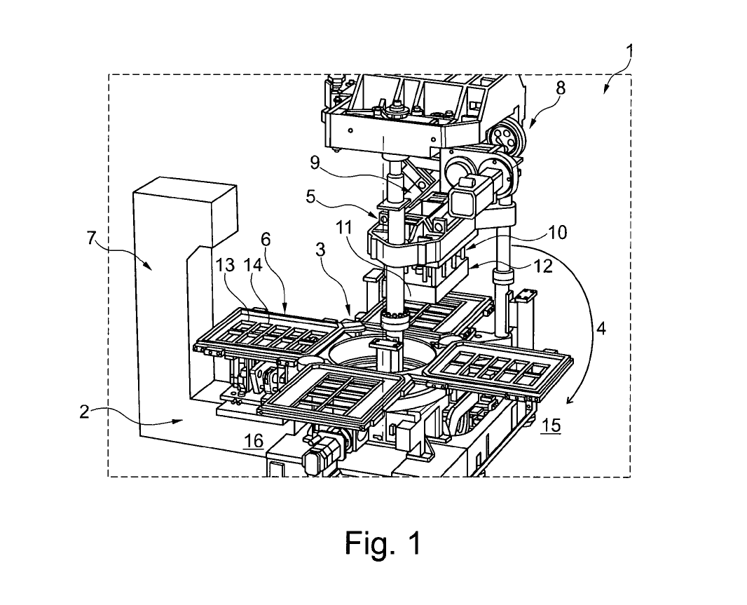

Machine 1 in FIG. 1 substantially comprises different stations which are arranged on one common bed 2 and connected in one machine direction 4 via a turntable 3.

The turntable 3 has a vertical switch shaft 5.

The turntable 3 has four workpiece trays 6 which are numbered by way of example.

A machine controller (not shown in detail) drives the turntable 3 with motors (not shown in detail) so that it can actuate the turntable 3 forward by a shifting angle of 90° each. In this way, a workpiece tray 6 can be shifted to precisely four positions.

Thus, the machine 1 with the workpiece trays 6 can move to exactly four stations.

It is explicitly pointed out that in other examples of embodiment, other numbers of trays, other carriers, other numbers of stations or other switching angles can be provided.

The machine 1 introduced here, however, is extremely compact, inexpensive and very precise as well as quick for a production.

In one of the positions that can be reached, a preform station 7 (shown only in a very rudimentary manner) is arranged. The preform station 7 has a compression molding die and, at its rear, a plastic melt (not shown) from an extruder (not shown).

The station subsequent to the preform station 7 in the machine direction 4 is a thermoforming station 8.

The thermoforming station 8 has an upper table 10 which can be moved vertically by means of a toggle lever drive 9 and has an upper die 11 attached to it which substantially contains a pre-stretching die (not shown) and a tenter 12.

The thermoforming station 8 additionally has a lower die (not shown) which has, as is known in the state of the art, a cavity for molding the thermoformed products (not shown) to be produced.

In the present example of embodiment, the workpiece trays 6 each have ten product bearing frames 13, 14 (numbered by way of example). Each workpiece tray 6 can therefore carry ten preforms and, one station further, also ten thermoformed products. Thus, with each switching cycle ten products or ten semi-finished products, respectively, per workpiece tray 6 are further moved.

The tenter 12 is so large that it encompasses the workpiece tray 6 with ten bearing frames, in any case the ten product bearing frames 13, 14.

Smaller tenters can be provided within the outer tenter 12, which can again clamp one or more workpieces so as to avoid slippage of rims of the thermoformed products through the product bearing frames 13, 14 while the form punch is pressed in or during thermoforming.

In another station, for instance in the third station, a removal station 15 can be provided. The fourth station of the example of embodiment introduced here is a free station 16 which can, however, also be used for cleaning or inspection purposes, for example.

In operation, the machine 1 produces thermoformed products in the following manner:

In a first step, a plastic produced with the compression-molding method, for instance by means of an extruder, is deposited at the preform station 7 and during the course of operation, a preform (not shown) is manufactured.

An additional step can already be performed here, for instance, provision with materials, printing, rim finishing, bottom finishing, a second component can be added etc.

The preforms produced are then removed from the preform cavities, for instance by lowering the preform cavities and indexing the turntable 3. In this manner, the preforms are moved into the thermoforming station 8. The preforms can still be deformed easily because they still retain their first heat.

The thermoforming station then performs the thermoforming in the manner known from the state of the art, preferably by means of a pre-stretching die.

For this purpose, the machine 1 will first fix the tenter 12 on the preforms and operate with the pre-stretching dies, but, in any case, with overpressure negative pressure, only afterwards.

Subsequently the thermoforming station 8 reopens again, the turntable 3 indexes to the next position, and the finished thermoformed products can be removed.

As mentioned above, other functions and additional stations can be provided as well.

Maybe it may be useful to apply barrier layers, sealing layers, color layers or prints.

For molding, compressed-air molding, vacuum molding, a pre-stretching die and a pressure can be used.

Secondary treatment can provide, for instance, a barrier layer, it can include printing, filling or sealing.

In any case, the machine makes it possible to arrive at the thermoformed product starting directly from the granules, with minimum space occupation, high working precision and high output. In spite of thin walls, high stability can be achieved by orienting of the macromolecules. In addition, the wall thickness distribution in the finished thermoformed product can be controlled by preform shaping.

The preform geometry preferably corresponds to the perpendicular projection of the final product, that is, production can be waste-free.

Functional elements such as a sealing lip, an energy director etc., can be introduced already during production of the preform.

1. A method for producing a thermoformed product on a single machine with several stations and with different tools, comprising the following steps:
a. melting and homogenizing plastic granules and providing the plastic melt at a preform station;
b. producing a preform at the preform station in a preform cavity, injection compression molding or compression molding;
c. transferring the preform by means of a transfer carrier to a thermoforming station at the same machine, the thermoforming station comprising a thermoforming tool having a thermoforming cavity;
d. preferably heating the preform during the transfer with a radiation heater;
e. thermoforming the thermoformed product in the thermoforming cavity.

2. A method for producing a thermoformed product on one or more machines, with several stations and with different tools, comprising the following steps:
a. providing a plastic mass at a preform station, either by melting and homogenizing plastic granules and providing the plastic melt at the preform station or by providing a solid plastic element, for instance a film portion, at the preform station;
b. producing a preform at the preform station in a preform cavity;
c. transferring the preform by means of a transfer carrier to a thermoforming station, the thermoforming station comprising a thermoforming tool having a thermoforming cavity and the transfer carrier holding the preform only on one side;
d. preferably heating the preform during the transfer, with a radiation heater;
e. fixing the preform to the thermoforming cavity by means of a tenter of the thermoforming station;
f. thermoforming the thermoformed product in the thermoforming cavity.

3. A method for producing a thermoformed product on one or more machines with several stations and with different tools, comprising the following steps:
a. providing a plastic mass at a preform station, either by melting and homogenizing plastic granules and providing the plastic melt at the preform station or by providing a solid plastic element, for instance a film portion, at the preform station;
b. producing a preform at the preform station in a preform cavity;
c. transferring the preform by means of a transfer carrier to a thermoforming station, the thermoforming station comprising a thermoforming tool having a thermoforming cavity;
d. preferably heating the preform during the transfer with a radiation heater;
e. thermoforming the cup-shaped product in the thermoforming cavity;
f. as well as an additional step altering the provided plastic mass, the preform and/or the thermoformed product, mechanically, optically or sensor technically.

4. A method for producing a thermoformed product on one or more machines, with several stations and with different tools, comprising the following steps:
a. melting and homogenizing plastic granules and providing the plastic melt at a preform station;
b. producing a preform at the preform station in a preform cavity by means of compression molding;
c. transferring the preform by means of a transfer carrier to a thermoforming station at the same machine, the thermoforming station comprising a thermoforming tool having a thermoforming cavity;
d. preferably heating the preform during the transfer, with a radiation heater;
e. thermoforming the thermoformed product in the thermoforming cavity.

5. The method according to claim 1 for producing a thermoformed product.

6. The method according to claim 1, wherein the preform is produced with a thickness profile deviating from a uniform thickness.

7. The method according to claim 1, with the following additional step: printing of the preform and/or of the thermoformed product by means of a printer, by means of a 3D printing process, by means of a liquid-jet printer; during rotation of the preform, the product and/or of the printer.

8. The method according to claim 1, with the following additional step: positioning an element in the thermoforming cavity, a label, a smart tag or an RFID chip, for connecting the element to the product.

9. The method according to claim 1, with the following additional step: positioning a multi-component preform in the preform cavity, by means of a two-component injection process, with one or two of the at least two components being injected and, in case of the injection of only one component, a second component being injected or introduced in some other manner.

10. The method according to claim 1, where a multi-layer film is provided for thermoforming.

11. The method according to claim 1 for producing a food capsule, a coffee capsule, with the additional steps: filling and/or sealing.

12. The method according to claim 1, the provision of the plastic mass at the preform station or of the plastic granules taking place with at least partial usage of a biologically degradable plastic according to the classification of the brochure Wolfgang Beier: “Hintergrund: Biologisch abbaubare Kunststoffe” of the Umweltbundesamt, August 2009.

13. The method according to claim 1, the provision of the plastic mass at the preform station or of the plastic granules taking place with at least partial usage of a polylactide (PLA).

14. The method according to claim 1, with the following additional step: applying a barrier layer, comprising an oxide.

15. The method according to claim 1, where a rim of the preform has already got its shape, in which it is clamped by the tenter, during the transfer.

16. The method according to claim 1, with the following additional step: Treating a rim of the preform, by applying a second plastic or a caoutchouc.

17. The method according to claim 1, wherein before thermoforming, a rim is formed to be an energy director.

18. The method according to claim 1, with the following additional step: Printing an electric oscillating or electronic circuit.

19. The method according to claim 1, with the following additional step: Printing a hologram on the thermoformed product.

20. The method according to claim 1, with the following additional step: Use of a combined IML embossing die, a label being employed which has a paint edge and an embossing having a mechanical edge, the contour of the paint edge being aligned with the one of the mechanical edge.

21. The method according to claim 1, wherein the production process for the preform uses precisely the amount of plastic required for the thermoformed product so that production takes place without waste.

22. An installation with more than one machine for performing the method according to claim 1.

23. Machine for performing a method according to claim 1.
